(19) United States
(12) Patent Application Publication
(10) Pub. No.: US 2026/0233542 A1
(43) Pub. Date: Aug. 13, 2026

(54) Thermally-Sublimable Metallic Film Material

(71) Applicant: CHANCE LINE INDUSTRIAL CO., LTD., Siansi Township (TW)

(72) Inventors: Ming-Hsien YAO, Siansi Township (TW); Ling-Ching YAO, Siansi Township (TW); Chun-Hsien YAO, Siansi Township (TW); Shipeng WANG, Siansi Township (TW)

(21) Appl. No.: 19/534,333

(22) Filed: Feb. 9, 2026

(30) Foreign Application Priority Data
Feb. 10, 2025 (TW) 114104899

(51) Int. Cl. B41M 5/035; B41M 5/50; D06Q 1/12

(52) U.S. Cl. CPC B41M 5/035; B41M 5/502; D06Q 1/12

(57) ABSTRACT

A thermally-sublimable metallic film material comprises: a base layer, and an adhesive layer, a metal layer, and a polyethylene terephthalate (PET) layer disposed on the base layer. The metal layer is an inner layer of the film material and provides the film material with a metallic texture. The PET layer is an outer layer of the film material. A thermal-sublimation ink thermally sublimated to the film material bonds to the PET layer to form a thermal-sublimation pattern, the thermal-sublimation pattern exhibits a metallic texture through the metal layer.

### FIELD OF THE INVENTION

The invention relates to a film material, specifically a film material capable of thermally sublimating patterns, enabling users to easily create thermal-sublimation patterns on the film material and providing the thermal-sublimation patterns with a metallic luster and vivid colors.

### DESCRIPTION OF THE RELATED ART

Plotter-cut films are available on the market, enabling consumers to create thermal-sublimation patterns with thermal-sublimation ink on the plotter-cut films. The patterns are then heat-pressed onto clothing using a hot melt adhesive of the plotter-cut film, enabling consumers to create various patterns on their garments.

However, existing plotter-cut films lack a metallic finish, thus failing to provide consumers with an ability to create thermal-sublimation patterns with metallic texture.

Furthermore, conventional plotter-cut films present several inconveniences in use. A conventional plotter-cut film 10, as shown in FIG. 1, comprises a release paper 11, a hot melt adhesive layer 12, and a polyurethane (PU) layer 14. One method of creating thermal-sublimation patterns on clothing using this plotter-cut film 10 is shown in FIGS. 2 to 5. Firstly, a pattern 17 is printed onto a thermal-sublimation paper 16 using a thermal-sublimation ink. Then, the thermal-sublimation paper 16 is brought into contact with the PU layer 14 of the plotter-cut film 10, and the plotter-cut film 10 and the thermal-sublimation paper 16 are subjected to high temperature with an electric iron, as shown in FIG. 2, causing the pattern 17 to thermally sublimate onto the PU layer 14. The thermal-sublimation paper 16 is then peeled off, as shown in FIG. 3. Then, as shown in FIG. 4, the plotter-cut film 10 is cut, as indicated by a cut line C, and the release paper 11 is peeled off. Finally, as shown in FIG. 5, the plotter-cut film 10 with the thermal-sublimation pattern 17 is heat-pressed onto a garment 19 with an electric iron, and the PU layer 14 and the pattern 17 are adhered to a surface of the garment 19, providing the garment 19 with the pattern 17.

The above-mentioned method of firstly thermally sublimating a pattern 17 and then heat-pressing the pattern 17 onto a garment is quite inconvenient and has many drawbacks for both consumers and manufacturers.

Firstly, in FIG. 2, when the pattern 17 is thermally-sublimated onto the plotter-cut film 10, an adhesive in the hot melt adhesive layer 12 melts and possesses fluidity. The release paper 11 is seamless, while the PU layer 14, coated on the hot melt adhesive layer 12, has pinholes. Therefore, the hot melt adhesive penetrates the PU layer 14, causing a surface of the PU layer 14 to adhere firmly to the thermal-sublimation paper 16. Consequently, after the pattern 17 is thermally sublimated, it is difficult for consumers to remove the thermal-sublimation paper 16, and a process of removing the thermal-sublimation paper 16 may damage the pattern 17.

Secondly, the hot melt adhesive adheres to the release paper 11, and a peel force between the hot melt adhesive layer 12 and the release paper is as high as 200-300 grams per inch of width, or even higher. This difficulty in separating the release paper 11 from the hot melt adhesive layer 12 makes it hard for consumers to remove the release paper 11, especially for small patterns, consumers find it difficult to peel the release paper 11 from the hot melt adhesive layer 12. The difficulty in peeling off the release paper 11 often results in damage to the plotter-cut film 10 and the pattern 17.

Drawbacks of the conventional plotter-cut film 10 include the fact that the thermal-sublimation ink combines with the PU layer 14, causing the thermal-sublimation ink to become unsaturated and lose its vividness, resulting in a color of the pattern 17 of the plotter-cut film 10 being dull and lacking luster. Furthermore, as shown in FIG. 9, after prolonged exposure, the thermal-sublimation ink in the conventional plotter-cut film 10 will spread, causing the thermal-sublimation pattern 17 to become blurry and unclear.

### SUMMARY OF THE INVENTION

One object of the invention is to provide a thermally-sublimable metallic film material capable of producing thermal-sublimation patterns with a metallic texture.

One object of the invention is to provide a thermally-sublimable metallic film material that enables a thermal-sublimation ink to sublimate into a vivid color on the film material.

One object of the invention is to provide a thermally-sublimable metallic film material, the film material has an adhesive layer and a base layer. The invention is capable of achieving a low peel force between the adhesive layer and the base layer, making them easy to separate and preventing damage to the film material and thermal-sublimation patterns on the film material.

One object of the invention is to provide a thermally-sublimable metallic film material capable of preventing the film material from sticking to a thermal-sublimation paper during fabrication of thermal-sublimation patterns.

One object of the invention is to provide a thermally-sublimable metallic film material capable of ensuring thermal-sublimation patterns on the film material to remain clear and unblurred after a long period of time.

A thermally-sublimable metallic film material provided by the invention comprising:

a base layer having release properties;

an adhesive layer disposed on the base layer;

a metal layer, one surface thereof being adhered to the adhesive layer; and

a transparent rigid polyethylene terephthalate (PET) layer, another surface of the metal layer being bonded to the PET layer, the PET layer being an outer layer of the film material.

Thereby, the metal layer provides the film material with a metallic texture, enabling patterns thermally sublimated onto the film material to exhibit a metallic texture.

Furthermore, a thermal-sublimation ink is thermally sublimated onto the film material and bonded to the PET layer of polyester material. The PET layer enables the thermal-sublimation ink to develop color, resulting in saturated and vivid hues. A pattern of the thermal-sublimation ink exhibits a vivid and glossy luster. Furthermore, the thermal-sublimation pattern remains clear and does not blur even after a long period of time.

When the pattern is thermally sublimated onto the film material, the metal layer is capable of withstanding high temperatures, preventing an adhesive of the adhesive layer from passing through the metal layer and reaching the PET layer and facilitating easy separation of the film material from a thermal-sublimation paper of the thermal-sublimation ink.

Preferably, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Preferably, the adhesive layer is made of hot melt adhesive, after the adhesive layer generates viscosity when heated, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Because a peel force between the base layer and the adhesive layer is low, the pattern can be directly thermally-sublimated onto the film material without prior peeling of the base layer. After the pattern is thermally-sublimated onto the film material, users can directly cut the film material, peel off waste materials other than the pattern, transfer the pattern using a transfer film, and heat press the pattern onto clothing.

Preferably, the metal layer is made of aluminum or silver.

Preferably, the adhesive layer is made of EVA hot melt adhesive, PSA pressure-sensitive adhesive (self-adhesive), thermoplastic polyurethane (TPU) hot melt adhesive, and polyethersulfone (PES) hot melt adhesive. According to the inventor's actual tests, a peel force between the adhesive layer using these materials and the base layer is between 20 grams and 100 grams per inch of width, making it easy to peel off.

Preferably, the PET layer is a biaxially oriented rigid PET film, which is rigid, flat, and has smooth surfaces. Preferably, a surface of the metal layer is flat and capable of reflecting light.

### BRIEF DESCRIPTION OF DRAWINGS

FIG. 1 is a cross-sectional view of a conventional plotter-cut film.

FIGS. 2 to 5 show a process of creating a thermal-sublimation pattern on clothing using a conventional plotter-cut film.

FIG. 6 is a photograph of a conventional plotter-cut film having a thermal-sublimation pattern.

FIG. 7 is a cross-sectional view of a thermally-sublimable metallic film material according to a preferred embodiment of the invention.

FIG. 8 is a photograph of a physical example of the metallic film material according to a preferred embodiment of the invention.

FIGS. 9 to 21 illustrate a process of forming a pattern printed with a thermal-sublimation ink onto a fabric using the metallic film material of the invention, wherein FIG. 13 shows a cross-sectional view of the thermal-sublimation ink thermally sublimated onto the metallic film material.

FIG. 22 shows a thermal-sublimation pattern formed on a fabric using the film material of the invention.

FIG. 23 shows another thermal-sublimation pattern formed on a fabric using the film material of the invention.

FIG. 24 is a photograph of the thermal-sublimation pattern of FIG. 23 viewed from a different angle.

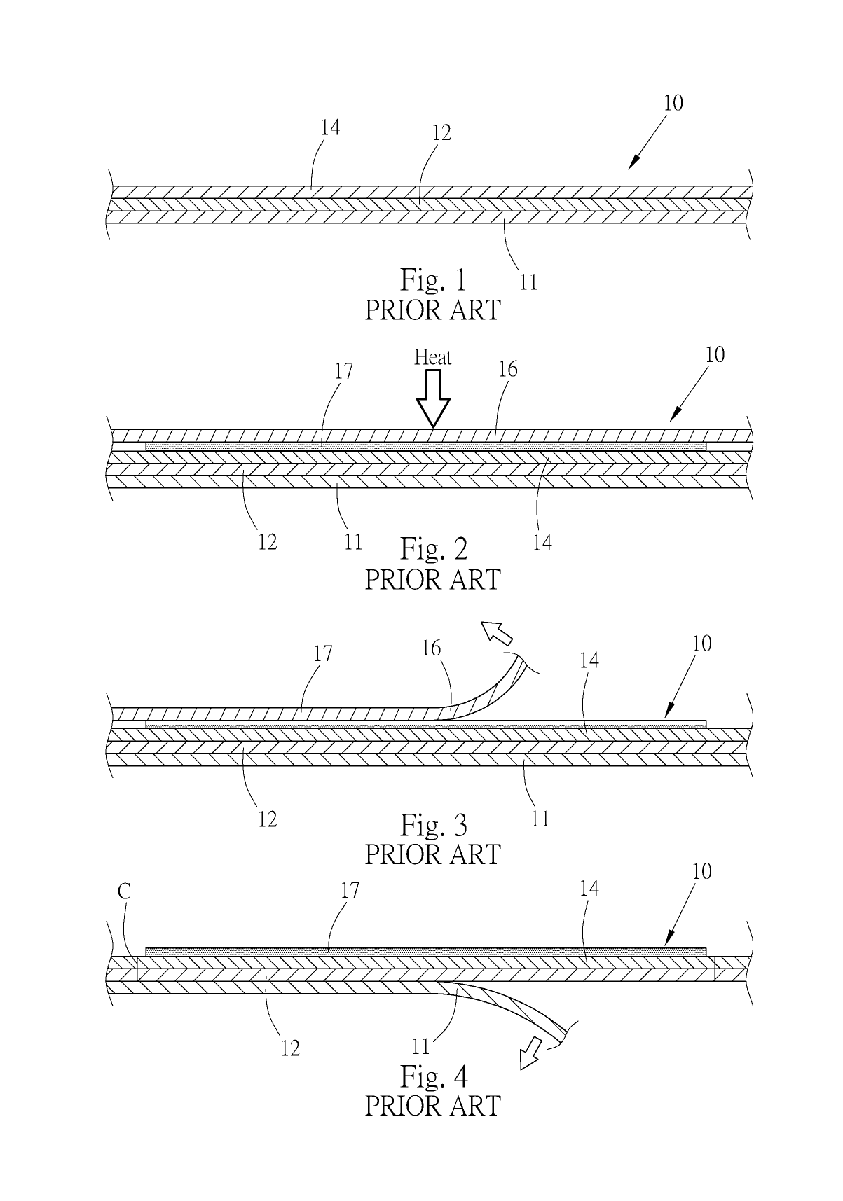

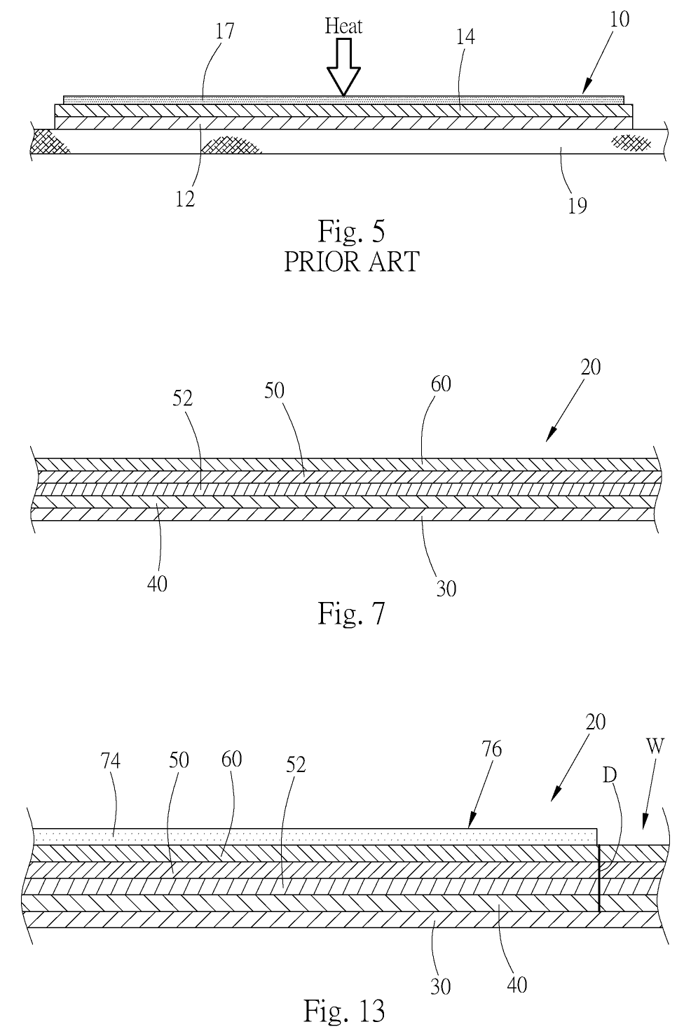

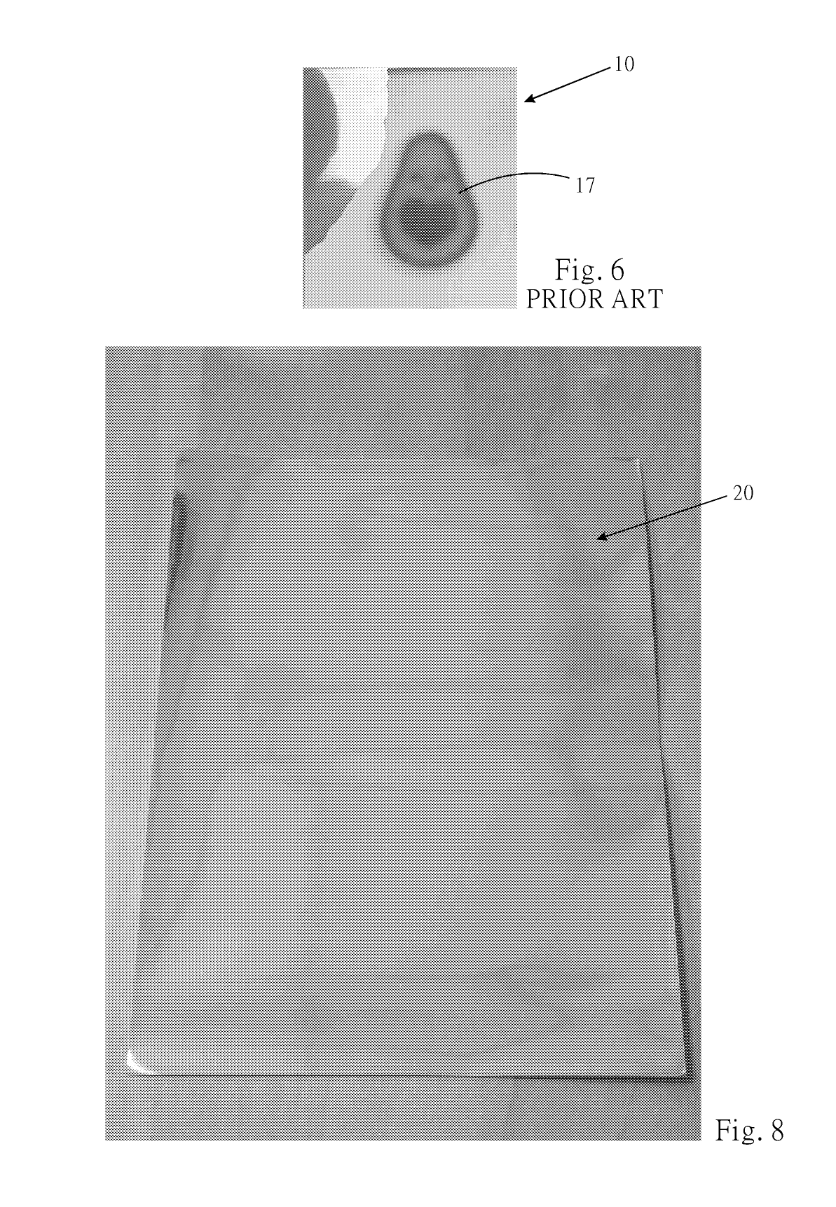

### DETAILED DESCRIPTION OF THE INVENTION

Please refer to FIG. 7, which illustrates a thermally-sublimable metallic film material 20 provided by a preferred embodiment of the invention. The metallic film material 20 (hereinafter referred to as the film material) of the invention is a pioneering product in this technical field; the prior art has never produced such the film material 20

with a metallic texture. The film material 20 comprises: a base layer 30; and an adhesive layer 40, a metal layer 50, and a transparent rigid polyethylene terephthalate (PET) layer 60 sequentially disposed on the base layer 30. The PET layer 60 is an outer layer of the film material 20, used to bond with a thermal-sublimation ink. The metal layer 50 is located below the PET layer 60, forming an inner layer of the film material 20, and is not exposed. Users can create thermal-sublimation patterns on the film material 20.

The base layer 30 is a carrier with release properties, which can be a release film or a release paper.

The adhesive layer 40 is disposed on one surface of the base layer 30. In the invention, after the adhesive layer 40 is subjected to a high temperature and generates viscosity, a peel force between the adhesive layer 40 and the base layer 30 is between 20 grams and 150 grams per 1 inch of width, preferably between 20 grams and 100 grams, and more preferably between 20 grams and 80 grams. Test conditions for the peel force are: the adhesive layer 40 and the base layer 30 are bonded together into a strip with a width of 1 inch, the adhesive layer 40 and the base layer 30 are pulled in opposite directions, and an acting force that can separate the adhesive layer 40 from the base layer 30 being the peel force. Therefore, after the film material 20 is heat-pressed, both adhesion force and peel force between the adhesive layer 40 and the base layer 30 are low, and the adhesive layer 40 and the base layer 30 can be easily separated. In this preferred embodiment, the adhesive layer 40 is a hot melt adhesive of the ethylene-vinyl acetate (EVA) copolymer series, which is solid at room temperature and melts into a viscous liquid adhesive (hot melt adhesive) when heated. The EVA hot melt adhesive layer 40 is polarized, making it easy to separate from the base layer 30 after the hot melt adhesive layer 40 generates viscosity. For the adhesive layer 40, pressure-sensitive adhesive (PSA) (also known as self-adhesive), or polarized thermoplastic polyurethane (TPU) hot melt adhesive, or polarized polyethersulfone (PES) hot melt adhesive can be used. According to the inventor's product and testing, a peel force between the adhesive layer 40 using these materials and the base layer 30 is between 20 grams and 150 grams per 1 inch of width. After the EVA hot melt adhesive layer 40 generates viscosity when heated, a peel force with the base layer 30 is 20~100 grams per inch of width, making it easy to separate. After the PES hot melt adhesive generates viscosity when heated, a peel force with the base layer 30 is also 20~100 grams per 1 inch of width.

In this preferred embodiment, the metal layer 50 is made of aluminum or silver, providing a bright metallic texture. The metal layer 50 is vacuumly plated (vacuum deposition) on one surface of the PET layer 60 using a vacuum deposition process, and the metal layer 50 has a smooth, mirror-like surface. Alternatively, the metal layer 50 can be formed by coating liquid aluminum or silver to the PET layer 60. Furthermore, since the metal layer 50 is made of metal, the metal layer 50 is heat-resistant and capable of withstanding temperatures at which the adhesive layer 40 generates viscosity when heated.

The transparent polyethylene terephthalate (PET) layer 60 is a biaxially oriented PET film, which is rigid, flat, smooth, and highly transparent. After the metal layer 50 is plated on the PET layer 60, the metal layer 50 and the PET layer 60 are then bonded to the adhesive layer 40 with a layer of adhesive 52, thus bonding the metal layer 50 to the adhesive layer 40. The adhesive 52 of the invention is developed by the inventor and overcomes a problem of difficult bonding of dissimilar materials, reliably bonding the metal layer 50 made of metal to the adhesive layer 40 without separation.

FIG. 8 is a photograph of a physical example of the film material 20 according to a preferred embodiment of the invention, wherein the metal layer 50 is made of aluminum. FIG. 8 shows that the film material 20 of the invention has a metallic texture and a mirror-like surface.

The following describes a process of thermally sublimating text or non-text patterns onto a fabric (e.g., clothing) using the metallic film material 20 of the invention in conjunction with a thermal-sublimation paper. The adhesive layer 40 of the film material 20 is exemplified by EVA hot melt adhesive.

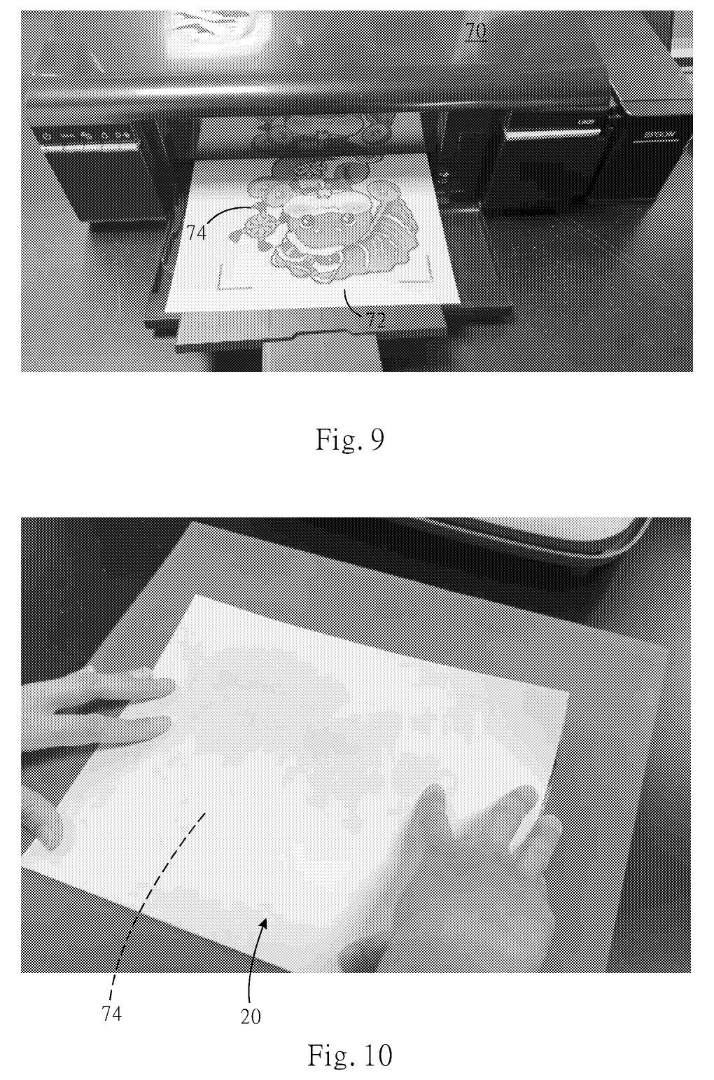

Please refer to FIG. 9, a user uses a household printer 70 to print a colored pattern 74 onto a thermal-sublimation paper 72 using a thermal-sublimation ink. The pattern 74 can be text (e.g., the English letters A, B, C) or non-text (e.g., people, landscapes, objects, symbols, etc.). The pattern 74 in FIG. 9 uses a cute animal as an example.

Please refer to FIG. 10, a film material 20 of the invention and the thermal-sublimation paper 72 printed with the pattern 74 are overlapped, with the pattern 74 contacting the PET layer 60 of the film material 20. Then, a heat press 77 or an iron is used to heat press the film material 20 and the thermal-sublimation paper 72, as shown in FIG. 11, for example, at a temperature of 205°C for 60 seconds.

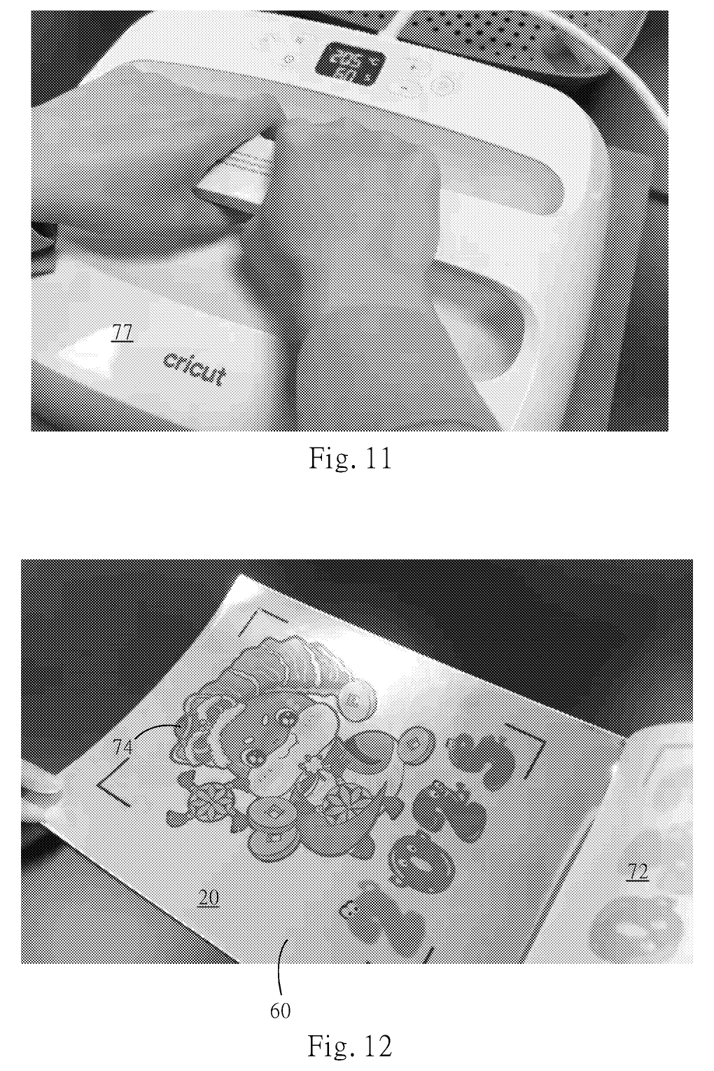

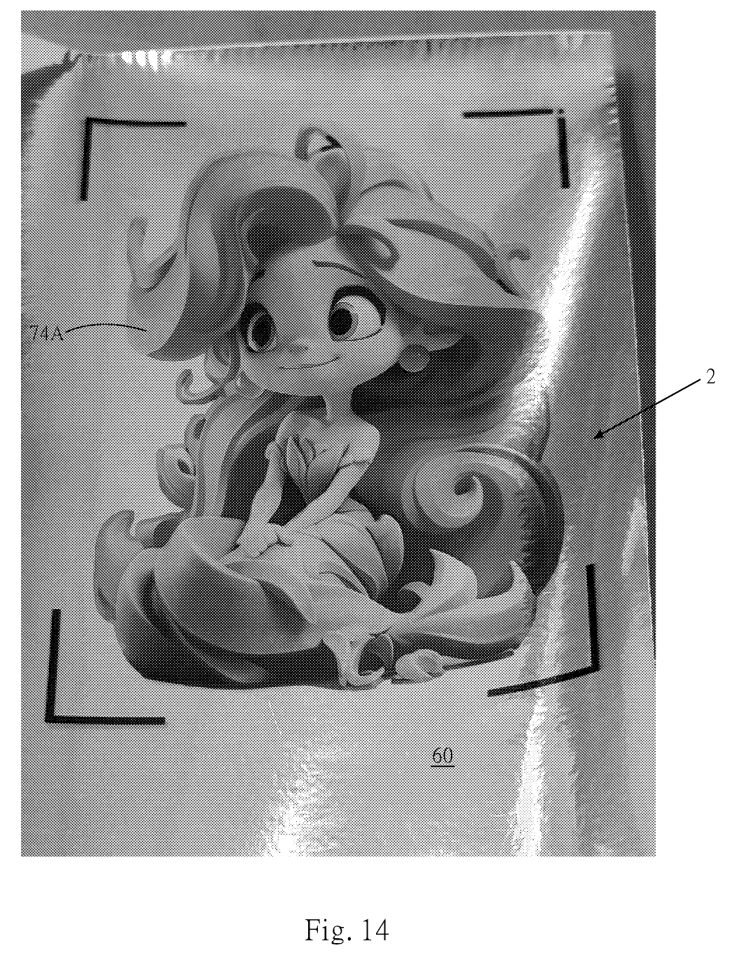

After heat pressing as shown in FIG. 11, the thermal-sublimation ink on the thermal-sublimation paper 72 is thermally sublimated onto the PET layer 60 of the film material 20. As shown in FIG. 12, the thermal-sublimation paper 72 is separated from the film material 20, revealing that the ink of the pattern 74 is thermally sublimated onto the PET layer 60 of the film material 20. Please refer to FIG. 13, the thermal-sublimation ink of the thermal-sublimation pattern 74 is bonded to the PET layer 60. FIG. 14 shows another metallic film material 20 of the invention, provided with another colored thermal-sublimation pattern 74A on the PET layer 60 of the film material 20.

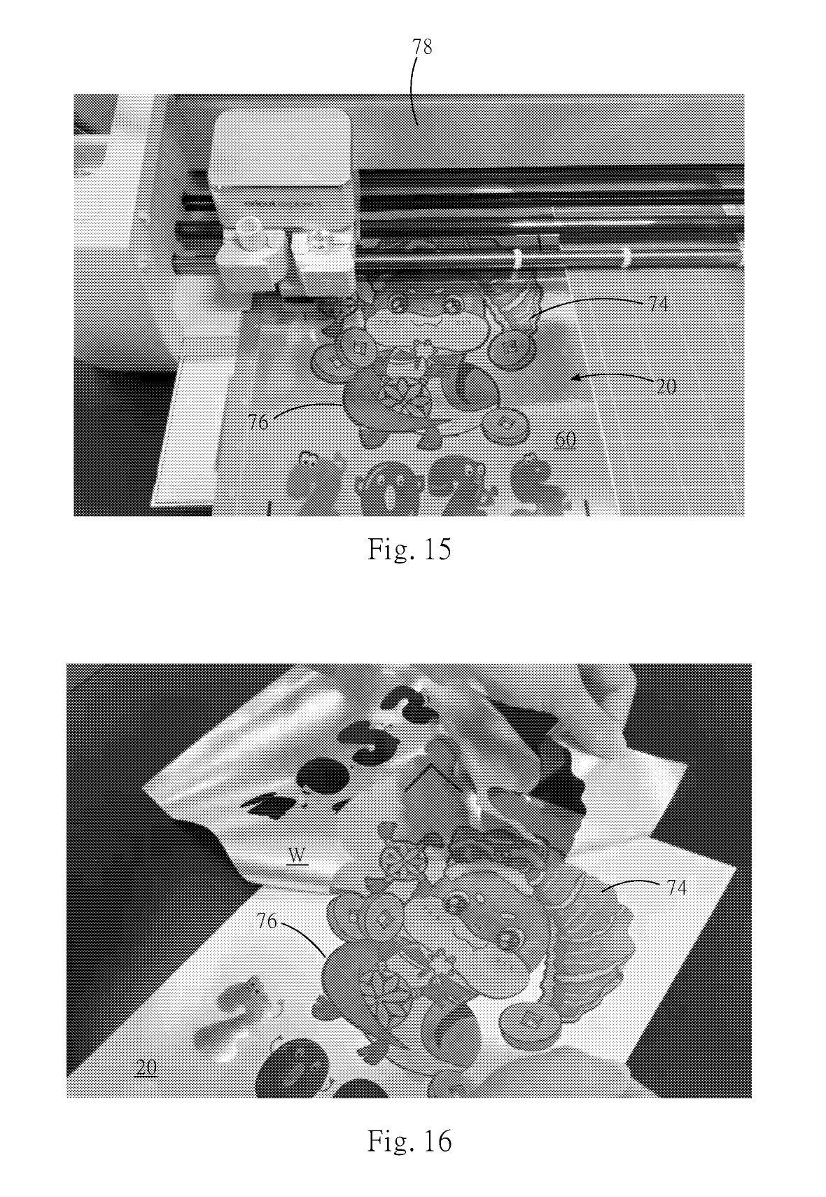

Subsequently, as shown in FIG. 15, a graphic 76 is cut from an outline of the pattern 74 using a household cutting machine 78, a cutting depth D of a cutter, as shown in FIG. 13, cuts through the PET layer 60, the metal layer 50, the layer of adhesive 52, and the adhesive layer (hot melt adhesive layer) 40, but does not cut through the base layer 30. After cutting, a waste material W other than the graphic 76 is removed, as shown in FIG. 16, leaving only the graphic 76 on the film material 20.

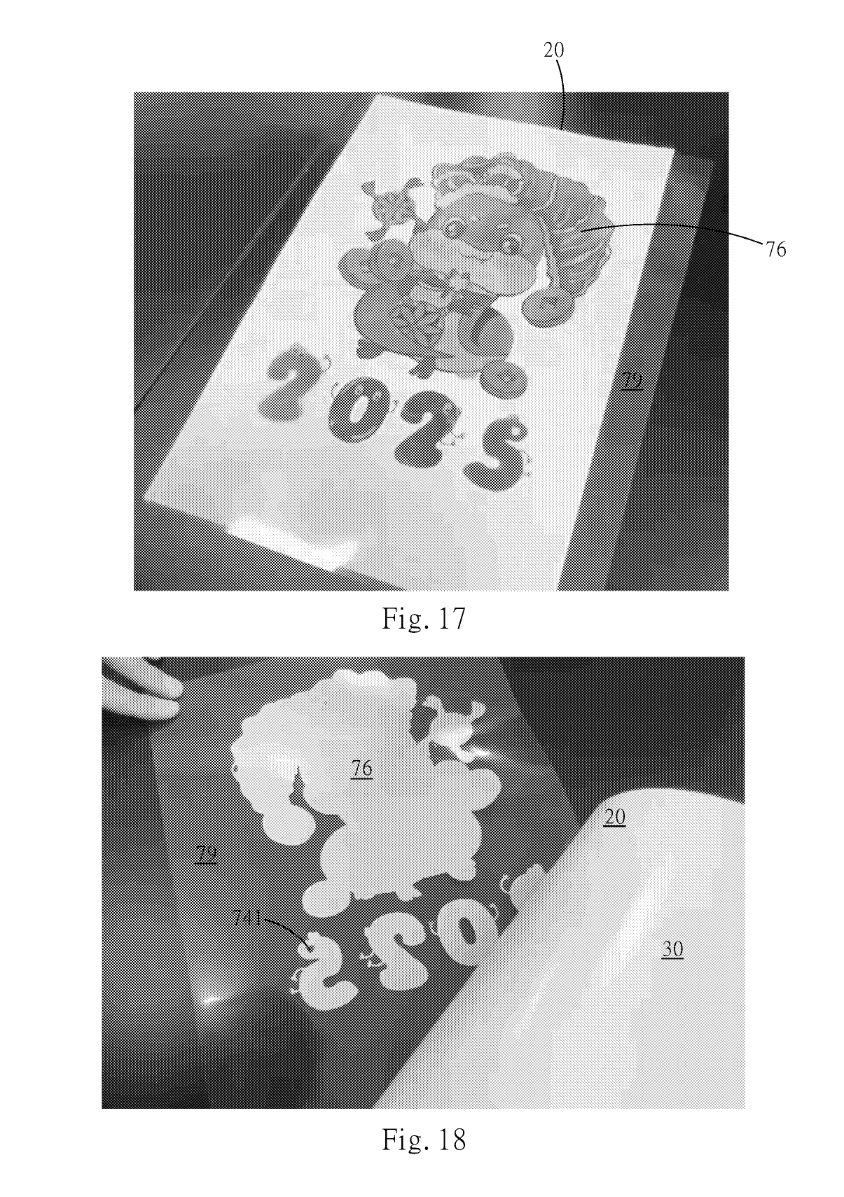

Then, as shown in FIG. 17, a transfer film 79 is adhered to the graphic 76, and the graphic 76 is then separated from the base layer 30 of the film material 20 by the transfer film 79, as shown in FIG. 18. The graphic 76 has the thermal-sublimation pattern 74, the PET layer 60, the metal layer 50, the layer of adhesive 52 and the adhesive layer 40.

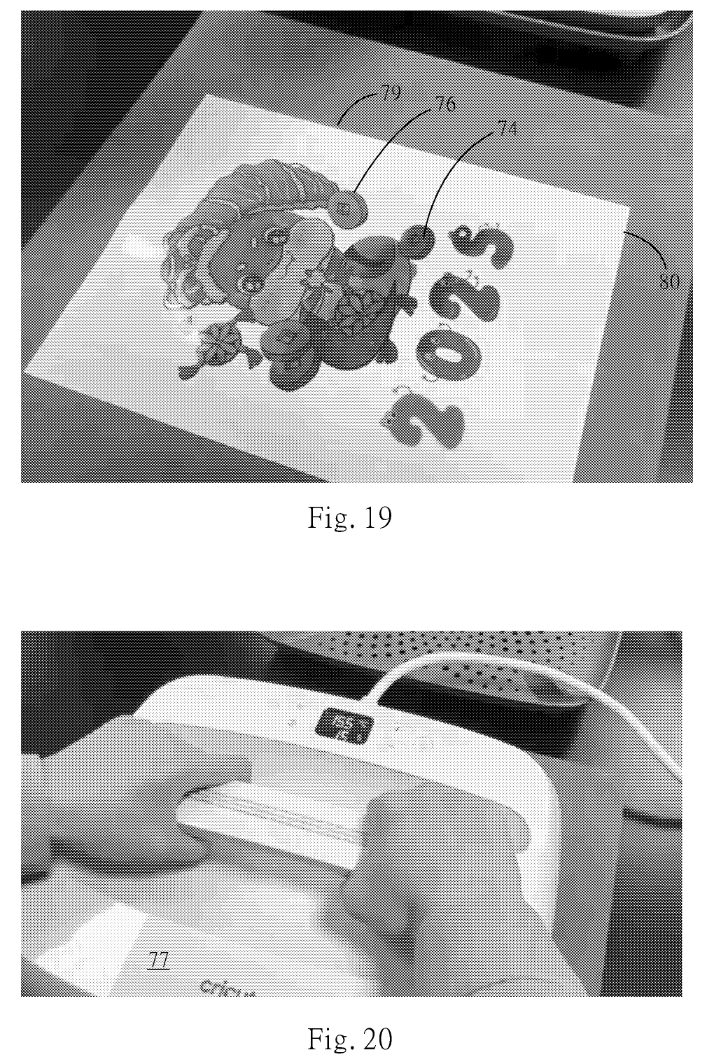

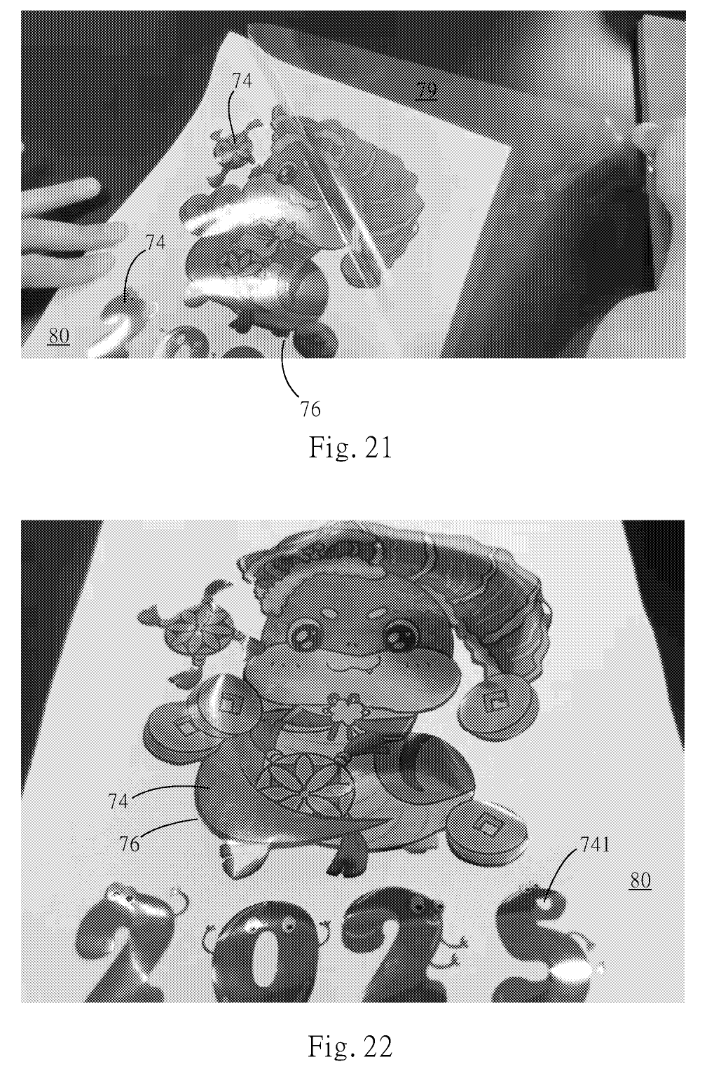

Please refer to FIG. 19, the graphic 76 is placed on a fabric 80 using the transfer film 79, with the adhesive layer (hot melt adhesive layer) 40 of the pattern 74 contacting the fabric 80. The graphic 76 is then heat-pressed, as shown in FIG. 20, for example, at 145°C for 30 seconds or at 155°C for 15 seconds. After heat pressing, the transfer film 79 is removed, as shown in FIG. 21, the graphic 76 (including the pattern 74) is adhered to the fabric 80 by an adhesive of the adhesive layer 40. FIG. 22 shows a finished product of the graphic 76 (including the pattern 74) heat-pressed onto the fabric 80.

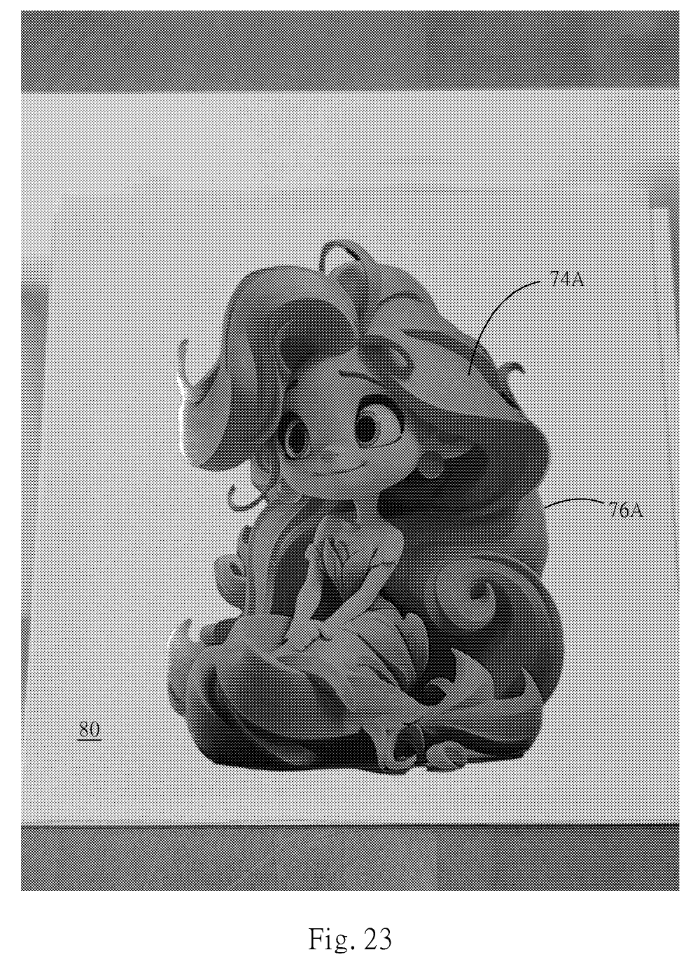

FIG. 23 shows another graphic 76A heat-pressed and adhered onto a fabric 80, the graphic 76A presents another thermal-sublimation pattern 74A.

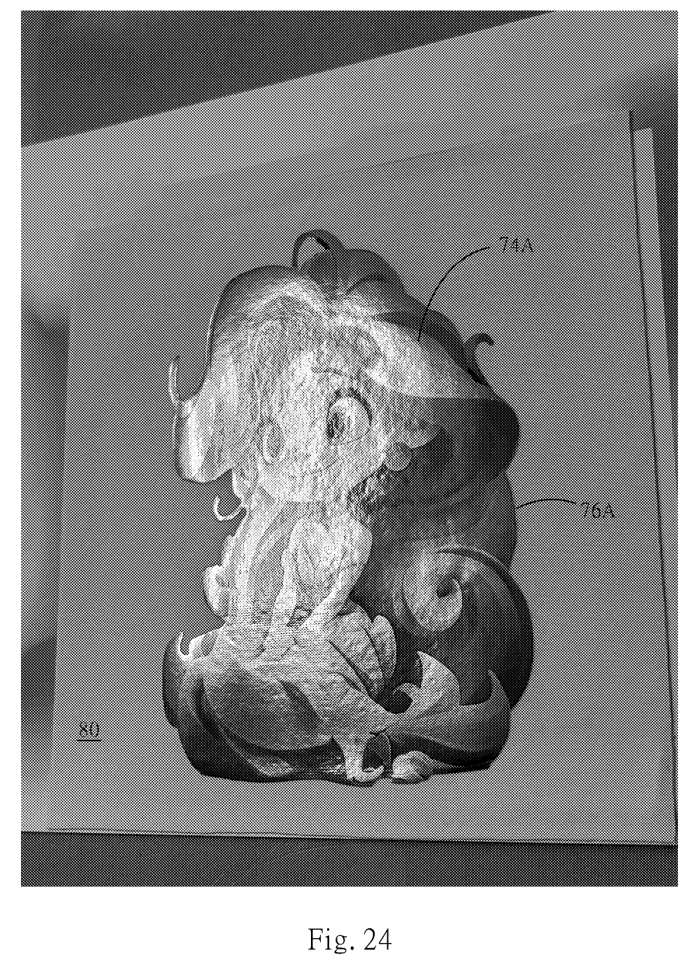

Light can penetrate the PET layer 60. The metal layer 50 provides the thermal-sublimation patterns 74, 74A a metallic texture, and the metal layer 50 is quite flat and capable of reflecting light. Therefore, the thermal-sublimation patterns 74, 74A are capable of reflecting light, as shown in FIGS. 21, 22 and 24.

The metallic film material 20 provided by the invention is a pioneering film material in the field of plotter-cut films, enabling users to create the thermal-sublimation patterns 74 (74A) with a metallic texture on the fabric 80, providing unprecedented pattern effects.

The PET layer 60 of the film material 20 is provided with polyester. When the thermal-sublimation ink of the pattern 74 (74A) is thermally sublimated to the PET layer 60, the thermal-sublimation ink bonds with the polyester material. The polyester enables the thermal-sublimation ink to develop color, making a color of the thermal-sublimation ink saturated and vivid. The pattern 74 has a bright, vivid color and a glossy finish. Furthermore, because the ink color is distinct, it is suitable for printing the pattern 74 in multiple colors with the thermal-sublimation ink. The patterns 74, 74A in FIGS. 22 and 23 all have multiple colors, and the colors are vivid and lines of the patterns 74, 74A are delicate. The PET layer 60 uses a rigid PET film, which makes the thermal-sublimation ink of the pattern 74 (74A) bright and clear, and enables for production of richly colored patterns with glossy hues.

By bonding the thermal-sublimation ink with polyester, the ink will not spread, and the thermal-sublimation patterns 74, 74A will remain clear and unblurred even after a long period of time.

The film material 20 of the invention enables consumers and businesses to easily create the various thermal-sublimation patterns 74 on the film material 20 and adhere the thermal-sublimation patterns 74 to a fabric, as shown in a manufacturing process in FIGS. 9 to 21. A peel force between the adhesive layer 40 and the base layer 30 is between 20 grams and 80 grams per square centimeter, making it easy to separate. In a heat pressing process shown in FIG. 11, when the thermal-sublimation ink of the thermal-sublimation paper 72 is thermally-sublimated onto the PET layer 60 of the film material 20, the hot melt adhesive layer 40 generates viscosity when heated. Because a peel force between the hot melt adhesive layer 40 and the base layer 30 is low, the hot melt adhesive layer 40 can be easily separated from the base layer 30. Therefore, when removing the waste material W as shown in FIG. 16, a user can easily tear off and remove the waste material W, and easily remove fine waste materials in the pattern 74, such as a small triangular waste material in the letter A, and a small waste in a small hollow area 741 of the pattern 74 as shown in FIGS. 18 and 22. A design of the hot melt adhesive layer 40, which is easily separable from the base layer 30, facilitates removal of fine and complex waste materials. Because the base layer 30 is easily separable from the hot melt adhesive layer 40, the base layer 30 can be easily and smoothly peeled off without damaging the thermal-sublimation pattern 74 and the film material 20. Since the hot melt adhesive layer 40 can be easily separated from the base layer 30 after the pattern 74 is thermally-sublimated onto the film material 20, the invention enables the graphic 76 to be cut on the plotter-cut film 20 without peeling off the base layer 30. The base layer is then peeled off after the graphic is cut.

In the invention, because the metal layer 50 is disposed under the PET layer 60, an adhesive of the adhesive layer 40 can be prevented from spreading upward to the PET layer 60. Therefore, during a thermal-sublimation process of the pattern 74 in FIG. 11, the thermal-sublimation paper 72 will not stick to the adhesive layer 40, making it easy to separate the thermal-sublimation paper 72 from the film material 20. In FIG. 20, when the graphic 76 is heat-pressed and adhered to the fabric 80, the metal layer 50 is capable of blocking an adhesive of the adhesive layer 40, preventing the adhesive from spreading upward to the PET layer 60 and the ink of the pattern 74.

The film material 20 of the invention enables consumers and businesses to create thermal-sublimation patterns according to a process shown in FIGS. 9 to 21. This method can produce discontinuous patterns. Discontinuous patterns are shown in FIG. 19, where the four Arabic numerals 2025 in the pattern 74 are separate and discontinuous.

The film material 20 of the invention enables individuals or businesses to create their own preferred thermal-sublimation pattern 74. Manufacturers of the film material 20 only need to produce small quantities of different styles for sale, thereby reducing display and storage spaces for goods sold, lowering manufacturing and inventory costs, and meeting environmental protection requirements.

Although the invention has been disclosed as above with the embodiments, they are not intended to limit the invention. A person having ordinary skill in the art to which the invention pertains can make various changes and modifications without departing from the spirit and scope of the invention. Therefore, a scope of protection of the invention shall be subject to what is defined in the pending claims.

What is claimed is:

1. A thermally-sublimable metallic film material comprising:
a base layer having release properties;
an adhesive layer disposed on the base layer;
a metal layer, one surface thereof being adhered to the adhesive layer; and
a transparent rigid polyethylene terephthalate (PET) layer, another surface of the metal layer being bonded to the PET layer, the PET layer being an outer layer of the film material.

2. The metallic film material as claimed in claim 1, wherein the metal layer is an aluminum layer or a silver layer.

3. The metallic film material as claimed in claim 1, wherein a peel force between the adhesive layer and the base layer is between 20 grams and 150 grams per inch of width.

4. The metallic film material as claimed in claim 1, wherein the adhesive layer is made of hot melt adhesive, after the adhesive layer generates viscosity when heated, a peel force between the adhesive layer and the base layer is between 20 grams and 150 grams per inch of width.

5. The metallic film material as claimed in claim 1, wherein the adhesive layer is made of hot melt adhesive; the metal layer is capable of withstanding temperatures at which the adhesive layer generates viscosity when heated.

6. The metallic film material as claimed in claim 1, wherein the adhesive layer is made of hot melt adhesive or pressure-sensitive adhesive.

7. The metallic film material as claimed in claim 6, wherein the hot melt adhesive is an ethylene-vinyl acetate (EVA) hot melt adhesive, a polyethersulfone (PES) hot melt adhesive or a thermoplastic polyurethane (TPU) hot melt adhesive.

8. The metallic film material as claimed in claim 1, wherein the PET layer is an oriented rigid PET film.

9. The metallic film material as claimed in claim 1, wherein the metal layer is capable of reflecting light.

10. The metallic film material as claimed in claim 1, wherein a thermal-sublimation ink is thermally sublimated onto and bonded to the PET layer of the metallic film material.
